(19) United States
(12) Patent Application Publication
(10) Pub. No.: US 2020/0043051 A1
(43) Pub. Date: Feb. 6, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kazuaki TAKEMURA, Nagoya-shi (JP); Yuko MIZUNO, Nagoya-shi (JP); Kohei MUTO, Toyota-shi (JP); Keiko NAGATOMI, Toyota-shi (JP); Masatoshi KOMIYAMA, Handa-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/527,095

(22) Filed: Jul. 31, 2019

(30) Foreign Application Priority Data
Aug. 3, 2018 (JP) 2018-146953

(51) Int. Cl. G06Q 30/02

(52) U.S. Cl. CPC G06Q 30/0266; G06Q 30/0277

(57) ABSTRACT

An information processing apparatus comprises a storage unit configured to store travel record information that contains identification data of advertisements displayed respectively by display apparatuses provided on a plurality of vehicles and records of location information of the vehicles by which the advertisements are displayed, the identification data of the advertisements and the records of location information being associated with each other; a controller configured to: receive a data retrieval request sent from a user terminal and containing information about the location of the user terminal, pick up one or more vehicles located close to the user terminal on the basis of the data retrieval request and the travel record information, create a list of advertisements displayed by the picked-up vehicles, and send the list of advertisements to the user terminal.

### CROSS REFERENCE TO RELATED APPLICATION

This application claims the benefit of Japanese Patent Application No. 2018-146953, filed on Aug. 3, 2018, which is hereby incorporated by reference herein in its entirety.

### BACKGROUND

### Technical Field

The present disclosure relates to technologies of providing advertisements using vehicles as media.

### Description of the Related Art

Advertising using vehicles as media has been developed in recent years. For example, an outside display apparatus is provided on a vehicle to display advertisements. The advertisement to be displayed is dynamically selected appropriately according to circumstances to optimize the effect of advertising.

### CITATION LIST

### Patent Literature

Patent Literature 1: Japanese Patent Application Laid-Open No. 2006-106742

Patent Literature 2: Japanese Patent Application Laid-Open No. 2002-157513

### SUMMARY

To enhance the effect of advertisement displayed using vehicles as media, it is desirable to invite customers who have seen the advertisement to access related information. For example, in the case of an advertisement about a sale in a store, it is desirable to show the way to the store and/or provide information about details of the sale for customers.

The present disclosure has been made in the above circumstances, and an object of the present disclosure is to provide an advertising system that can provide easy access to information relating to an advertisement displayed using a vehicle as an advertising medium.

The present disclosure in its one aspect provides an information processing apparatus comprising a storage unit configured to store travel record information that contains identification data of advertisements displayed respectively by display apparatuses provided on a plurality of vehicles and records of location information of the vehicles by which the advertisements are displayed, the identification data of the advertisements and the records of location information being associated with each other; a controller configured to receive a data retrieval request sent from a user terminal and containing information about the location of the user terminal, pick up one or more vehicles located close to the user terminal on the basis of the data retrieval request and the travel record information, create a list of advertisements displayed by the picked-up vehicles, and send the list of advertisements to the user terminal.

The present disclosure in its another aspect provides an information processing method comprising the steps of obtaining travel record information that contains identification data of advertisements displayed respectively by display apparatuses provided on a plurality of vehicles and records of location information of the vehicles by which the advertisements are displayed, the identification data of the advertisements and the records of location information being associated with each other; receiving a data retrieval request sent from a user terminal and containing information about the location of the user terminal; picking up one or more vehicles located close to the user terminal on the basis of the data retrieval request and the travel record information; and creating a list of advertisements displayed by the picked-up vehicles and sending the list of advertisements to the user terminal.

An information processing apparatus according to a third aspect of the present disclosure comprises a program that causes a computer to implement the above-described information processing method or a computer-readable recording medium in which the program is stored in a non-transitory manner.

The present disclosure can provide an advertising system that can provide easy access to information relating to an advertisement displayed using a vehicle as an advertising medium.

### BRIEF DESCRIPTION OF THE DRAWINGS

FIG. 1 is a diagram illustrating the general configuration of an advertisement distribution system according to an embodiment.

FIG. 2 is a diagram illustrating the system configuration of a vehicle 10 according to a first embodiment.

FIG. 3 illustrates the positions of display apparatuses provided on vehicles 10.

FIG. 4 is a diagram illustrating the system configuration of a server apparatus 20 according to the first embodiment.

FIG. 5 illustrates an example of an advertisement information table stored in a database.

FIG. 6 illustrates an example of a vehicle information table stored in a database.

FIG. 7 illustrates an example of a travel record table stored in a database.

FIG. 8 is a diagram illustrating the system configuration of a user terminal 30 according to the first embodiment.

FIG. 9 is a flow chart of a process executed by the server apparatus 20.

FIG. 10 is a flow chart of a process executed by the vehicle 10.

FIG. 11 is a flow chart of the process of providing information relating to an advertisement to the user terminal 30.

FIG. 12 is a map illustrating an area in which vehicles 10 are picked up.

FIG. 13 shows an example of an advertisement list provided to the user terminal 30.

### DESCRIPTION OF THE EMBODIMENTS

An advertisement distribution system according to the present disclosure includes a server apparatus and a plurality of vehicles. The server apparatus distributes an advertisement to the plurality of vehicles, and the vehicles display the advertisement on their respective display apparatuses.

Each vehicle in the system according to the embodiment outputs an advertisement (in the form of a still or moving image) it has received from the server apparatus on an outside display apparatus provided on the vehicle body while it is travelling. It is desirable for the system as above to provide circumstances that allow consumers who have seen the advertisement to easily access information relating to the advertisement. Such consumers will be hereinafter referred to as “users”.

To this end, the server apparatus that manages advertisements in the advertisement distribution system according to the present disclosure is configured to store travel record information that contains identification data of advertisements displayed by vehicles and records of location information of the vehicles by which the advertisements are displayed, the identification data of the advertisements and the records of location information being associated with each other. When a request is made by a terminal (user terminal) that a user has, the server apparatus picks up one or more vehicles located close to the user terminal on the basis of the travel record information stored in it and location information of the user terminal. Moreover, the server apparatus creates a list of advertisements displayed by the picked-up vehicles and sends the list of advertisements to the user terminal.

Thus, the advertisement distribution system can provide further information about the advertisements displayed by the vehicles located close to the user terminal.

Further, the controller may obtain identification data of an advertisement selected from the list by the user terminal, retrieve detailed information associated with the advertisement selected by the user terminal, and send the detailed information to the user terminal. This facilitates access to the detailed information related to the advertisement.

The travel record information may include information representing the locations of the vehicles at respective points in time, the data retrieval request may further contain information indicating a first point in time designated by the user terminal, and the controller may be configured to further use the first point in time in picking up vehicles.

To pick up vehicles that the user is supposed to have seen, it is preferable to use the time as well as the distance.

Further, when creating the list by picking up vehicles, the controller may give priority to vehicles whose distance to the user terminal in a time-space network is short.

In other words, in the process of picking up vehicles, the controller may give higher priority to vehicles that are closer to the user terminal in terms of space and time. Thus, vehicle that are supposed to have been seen by the user with high probability can be picked up with higher priority. This enables prioritization in the list of advertisements.

Further, the controller may periodically receive location information of the vehicles that are travelling and update the travel record information.

Thus, information about the locations of the vehicles at respective points in time can be recorded. This can improve the accuracy of identification of the vehicle seen by the user.

In the following, specific embodiments of the present disclosure will be described with reference to the drawings. It should be understood that features such as hardware configurations, module configurations, and functional configurations that will be described in connection with the embodiments are not intended to limit the technical scope of the present disclosure only to them, unless otherwise stated.

### First Embodiment

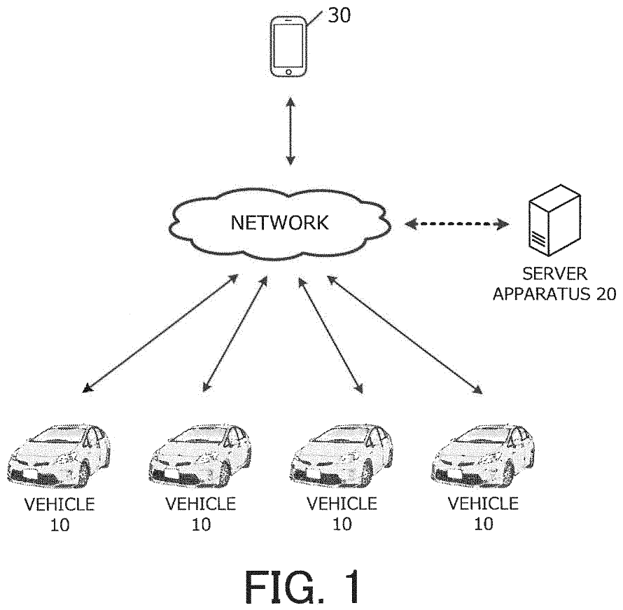

FIG. 1 illustrates the general configuration of an advertisement distribution system according to a first embodiment. The advertisement distribution system according to the first embodiment includes a plurality of vehicles 10, a server apparatus 20, and user terminals 30 carried by users. In the context of the description of this embodiment, the term “users” refers to an intended audience of an advertisement output by the vehicles 10.

The vehicle 10 is an automobile provided with a plurality of display apparatuses on the outside of its body. The vehicle 10 is capable of displaying an advertisement using advertisement data it has received from the server apparatus 20. The expression “displaying an advertisement” in the description of the embodiment means outputting image data to a display apparatus to display a still or moving image on it. The number of vehicles 10 included in the system is not limited to that in the illustrated case, but the system may include any number of vehicles 10.

The vehicle 10 receives advertisement data from the server apparatus 20 and outputs an advertisement to the display apparatuses while it is travelling. The vehicle 10 periodically sends location information and information about the advertisement displayed at the time to the server apparatus 20.

The server apparatus 20 is a server that manages the vehicles 10 and advertisements to be displayed by the vehicles 10. The server apparatus 20 has data relating to advertising and data about the vehicles 10. The server apparatus 20 determines advertisements to be distributed to the vehicles 10, distributes advertisements to the vehicles 10, and performs management of results (e.g. makes a report to the advertiser or client).

The server apparatus 20 also manages the locations of travelling vehicles 10, records of their travel, identification data of the advertisements displayed by the vehicles 10.

Further, the server apparatus 20 has the function of providing detailed information relating to advertisements displayed by the vehicles 10 in response to a request sent from a user terminal 30.

The user terminal 30 is a terminal carried by a consumer (user). The number of user terminals 30 included in the system is not limited to that in the illustrated case, but the system may include any number of user terminals 30.

When requested from a user terminal 30, the server apparatus 20 picks up a plurality of vehicles 10 located in the vicinity of the user terminal 30, creates a list of advertisements displayed by the picked-up vehicles, and sends it to the user terminal 30. If an advertisement(s) is selected by the user terminal 30, the server apparatus 20 provides detailed information about the selected advertisement(s) to the user terminal 30.

The vehicles 10, the server apparatus 20, and the user terminals 30 in the advertisement distribution system according to the embodiment are interconnected by a network. Examples of the network include a wide area network (WAN), namely a global public network, such as the Internet, and other communication networks. Examples of the network also include a telephone communication network, such as a cellular phone network, or other wireless communication networks, such as Wi-Fi (registered trademark).

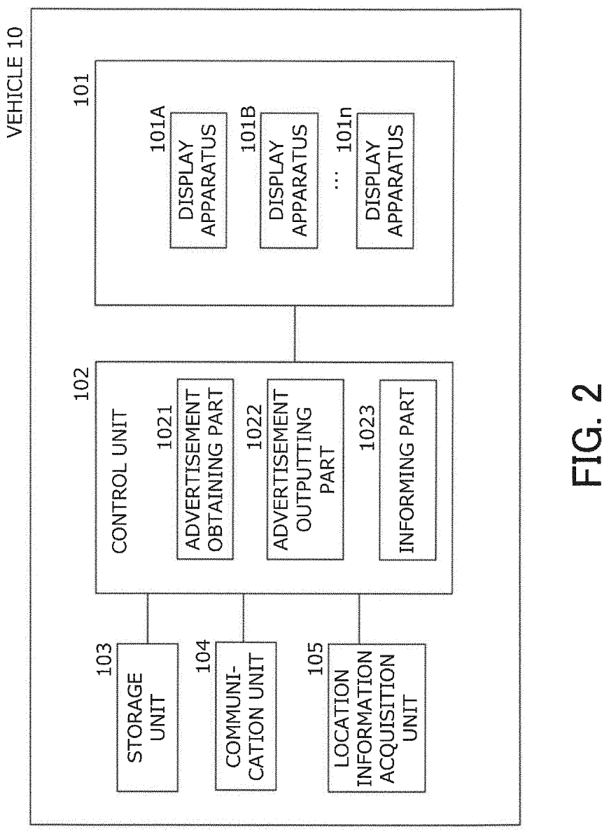

Now, the configuration of the vehicle 10 will be described. FIG. 2 is a diagram illustrating the system configuration of the vehicle 10.

The vehicle 10 includes a display unit 101, a control unit 102, a storage unit 103, a communication unit 104, and a location information acquisition unit 105.

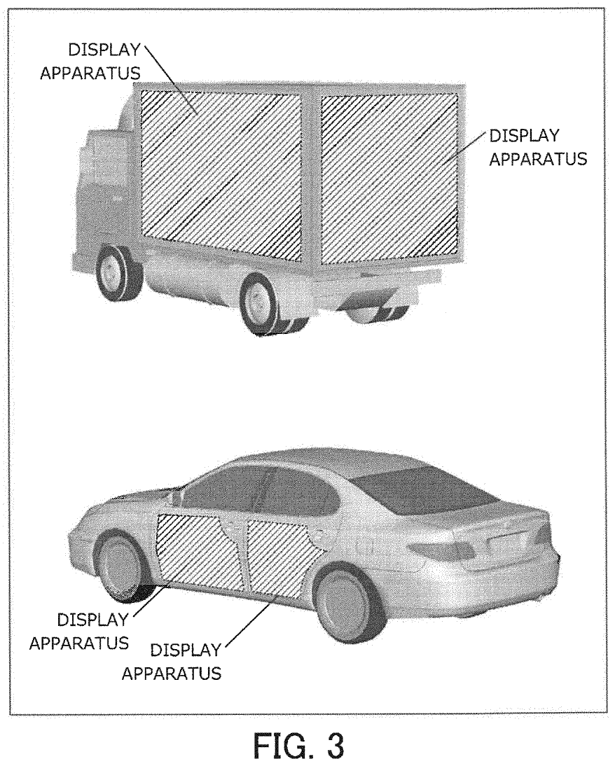

The display apparatus 101 includes a plurality of display apparatuses provided on the outside of the vehicle 10. As illustrated in FIG. 3, the vehicle 10 in the system according to the embodiment has a plurality of display apparatuses 101A, 101B, . . . , 101n that face outward. The display apparatuses will be collectively designated as the display apparatus 101, where identification of individual display apparatuses is not necessary.

The display apparatus 101 may be a liquid crystal display, an organic electroluminescence display, an LED matrix, or a projector.

The number of display apparatuses provided on one vehicle 10 varies depending on the type or model of the vehicle 10. Display apparatuses may be provided on different portions of the vehicle 10, for example, on the right and left sides, the rear, and the top of the vehicle. For example, a truck may have three display apparatuses provided on the right side, the left side, and the rear of the vehicle. A sedan may have four display apparatuses provided on the front door on the left side, the rear door on the left side, the front door on the right side, and the rear door on the right side.

Display apparatuses 101 may be provided at positions other than those described above. For example, if it is possible to project images on a sheet of glass, display apparatuses may be provided on windows (e.g. side and rear windows).

The control unit 102 is a computing device that controls the function of outputting advertisements among the functions of the vehicle 10. The control unit 102 may be implemented by a computational processing unit, such as a CPU (Central Processing Unit).

The control unit 102 includes three functional modules, which include an advertisement obtaining part 1021, an advertisement outputting part 1022, and an informing part 1023. These functional modules may be implemented by executing programs stored in the storage unit 103 (described later) by a CPU.

The advertisement obtaining part 1021 obtains data (advertisement data) relating to an advertisement to be output on the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an advertisement contained in the advertisement data to the display apparatus 101. A condition for outputting the advertisement may be specified in the advertisement data, and the advertisement may be output only when the condition is met. The advertisement data may designate the position and the size of the display apparatus, and the advertisement outputting part 1022 may output the advertisement according to the designations.

The informing part 1023 sends information about display of an advertisement to the server apparatus 20. Specifically, the informing part 1023 collects information about the present location of the vehicle, identification data of the advertisement presently displayed, and other information relating to the advertisement and sends them to the server apparatus 20.

Details of processing executed by each module will be described later.

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE.

The location information acquisition unit 105 is a unit configured to acquire location information of the vehicle 10. The location information acquisition unit 105 includes, for example, a GPS module and acquires location information (e.g. latitude and longitude) of the vehicle 10.

FIG. 2 is given only to illustrate an exemplary configuration, and all or some of the functions shown in FIG. 2 may be implemented by circuits dedicated to the functions. Main and auxiliary storage devices other than those illustrated may be employed in combination to store and/or execute programs.

Next, the configuration of the server apparatus 20 will be described.

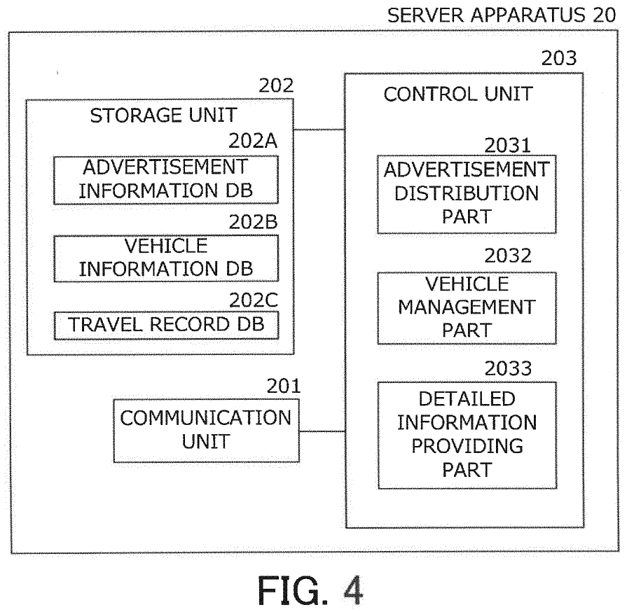

FIG. 4 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will be described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for providing wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record data base 202C.

The advertisement information database 202A is a database in which data relating to advertisements to be distributed to the vehicles 10 is stored. Such data is created by an advertiser(s).

The vehicle information data base 202B is a database in which information about properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has traveled, the status of display of an advertisement, and identification data of the displayed advertisement. The stored data is updated on the basis of information collected from the vehicles 10.

These databases are created by managing data stored in the storage device by a database management system program (DBMS program) executed by the processor. The databases used in the system according to the embodiment are, for example, relational databases.

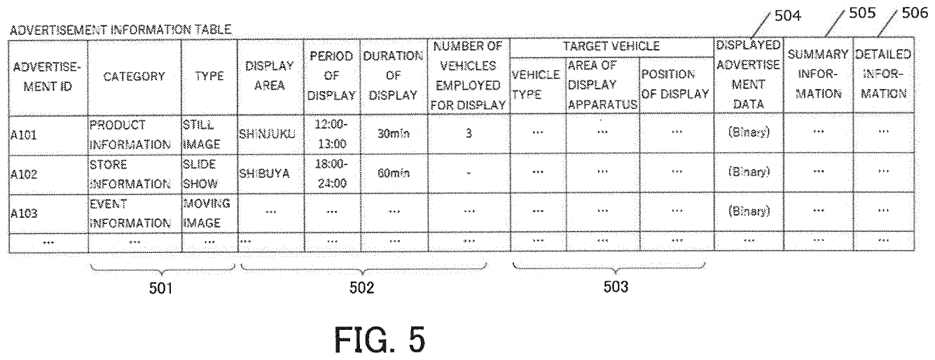

Data stored in the advertisement information database 202A will now be described with reference to FIG. 5. FIG. 5 illustrates an example of the content of an advertisement information table stored in the advertisement information database 202A. As illustrated, the information stored in the advertisement information table includes information relating to properties of the advertisement (501), information relating to conditions for display of the advertisement (502), information designating a vehicle to be employed to display the advertisement (503), data to be output to the display apparatus 101 of the vehicle (504), summary information that summarizes the advertisement (505), and detailed information of the advertisement (506). The summary information and the detailed information may be either a plain text or a document written in a markup language. Each data stored in the advertisement information database 202A will be referred to as “advertisement data”.

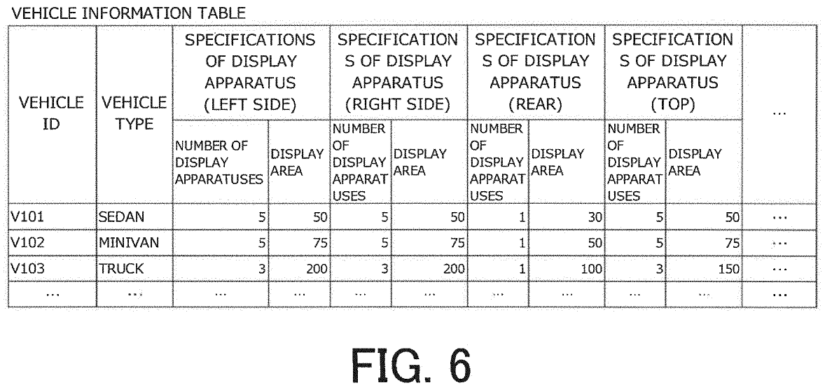

Next, data stored in the vehicle information database 202B will be described with reference to FIG. 6. FIG. 6 illustrates an example of the content of a vehicle information table stored in the vehicle information database 202B. The information stored in the vehicle information table includes information about the type of the vehicle and information about the display apparatus. Examples of the information about the display apparatus include, but are not limited to, the positions at which the display apparatuses are provided, the number of panels in each position, and the area of each display.

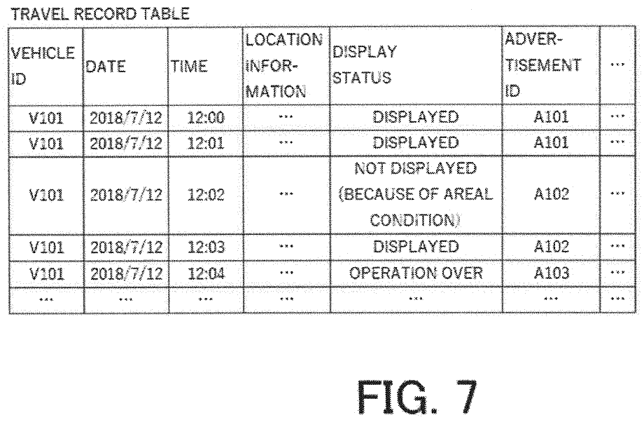

Data stored in the travel record database 202C will be described with reference to FIG. 7. FIG. 7 illustrates an example of the content of a travel record table stored in the travel record database 202C. Information stored in the travel record table includes identification data of the vehicle (VEHICLE ID), date and time, location information (e.g. latitude and longitude) of the vehicle 10, the status of display of advertisement, identification data of the advertisement displayed at the time (ADVERTISEMENT ID).

The display status is information indicating the status of display of advertisement, examples of which include “DISPLAYED”, “NOT DISPLAYED”, “PARKED”, and “OPERATION OVER” (indicating that the operation has ended). When display of advertisement is not performed for some reason, such as that the vehicle 10 is travelling outside the area designated by the advertiser or the time of travel does not fall in the designated time period, the display status may include the reason.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules an advertisement distribution part 2031, a vehicle management part 2032, and a detailed information providing part 2033. These three functional modules may be implemented by executing programs stored in auxiliary storage device by the CPU.

The advertisement distribution part 2031 determines an advertisement to be displayed by a designated vehicle 10 and sends corresponding advertisement data to the vehicle 10.

The vehicle management part 2032 periodically communicates with the vehicles 10 to collect location information of the vehicles 10 and identification data of the advertisements displayed by the vehicles 10 and updates the travel record database 202C.

In response to a request from a user terminal 30, the detailed information providing part 2033, picks up one or more vehicles 10 located close to the user terminal 30, creates a list of advertisements displayed by the picked-up vehicles, and sends the list to the user terminal 30. If one of the advertisements in the list is designated by the user terminal 30, the detailed information providing part 2033 acquires the detailed information of the advertisement and sends it to the user terminal 30.

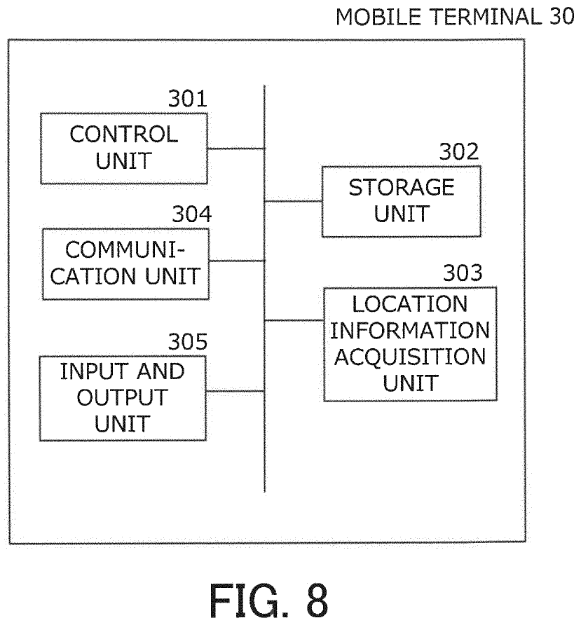

Next, the configuration of the user terminal 30 will be described. FIG. 8 is a diagram illustrating the system configuration of the user terminal 30.

The user terminal 30 is a small computer, such as a smartphone, a cellular phone, a tablet computer, a personal information terminal, a laptop personal computer, or a wearable computer (e.g. smartwatch). The user terminal 30 includes a control unit 301, a storage unit 302, a location information acquisition unit 303, a communication unit 304, and an input and output unit 305.

The control unit 301 is a computing unit that executes control performed by the user terminal 30. The control unit 301 may be implemented by a computational processing unit, such as a CPU (Central Processing Unit).

The control unit 301 executes the function of accessing the server apparatus 20 to request detailed information of an advertisement displayed by a vehicle 10.

Details of its processing will be described later.

The storage unit 302 includes a main storage device and an auxiliary storage device. The main storage device is a memory into which programs executed by the control unit 301 and data used by such control programs are loaded. The auxiliary storage device is a device in which the programs executed by the control unit 301 and the data used by the control programs are stored. A package of application programs executed by the control unit 301 may be stored in the auxiliary storage device. An operating system for executing the application programs may also be stored in the auxiliary storage device. Programs stored in the auxiliary storage device are loaded into the main storage device and executed by the control unit 301 to execute processing described in the following.

The main storage device may include a RAM (Random Access Memory) and/or a ROM (Read Only Memory). The auxiliary storage device may include an EPROM (Erasable Programmable ROM) and/or a hard disk drive (HDD). The auxiliary storage device may also include a removable medium, namely portable recording medium. Examples of the removable medium include a USB memory (Universal Serial Bus memory) and a recording disc medium, such as a CD (Compact Disc) or a DVD (Digital Versatile Disc).

The location information acquisition unit 303 is a unit configured to acquire location information of the user terminal 30. The location information acquisition unit 303 includes, for example, a GPS module and acquires location information (e.g. latitude and longitude) of the user terminal 30.

The communication unit 304 is a wireless communication interface that connects the user terminal 30 to the network. The communication unit 304 provides access to the network via, for example, a wireless LAN or a mobile communication service based on 3G or LTE.

The input and output unit 305 is a unit configured to receive input operations by a user and providing information to the user. The input and output unit 305 of the user terminal 30 according to the embodiment is constituted by a single touch-panel display, which includes a liquid crystal display, its control unit, a touch panel, and its control unit.

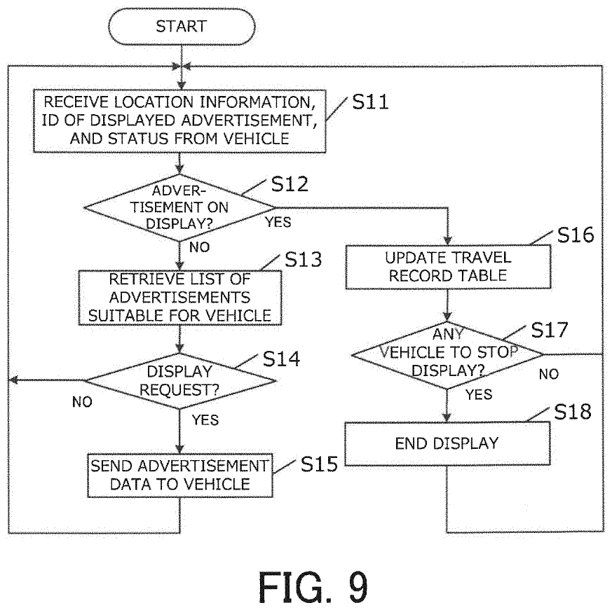

The advertisement distribution system according to the embodiment distributes advertisements to the vehicles 10 to let them display the advertisements. The process of distributing and displaying advertisements will now be described. FIG. 9 is a flow chart of a process executed by the server apparatus 20. The management server 20 executes the process illustrated in FIG. 9 periodically for each of the vehicles 10 under its management.

Firstly in step S11, the server apparatus 20 collects from the vehicles 10 under its management location information, the identification data of the presently displayed advertisement, and the status of display of advertisement. Specifically, the vehicle management part 2032 sends an inquiry to each of the vehicles 10 (specifically, the informing part 1023 thereof), and the informing part 1023 of each vehicle 10 sends location information acquired by the location information acquisition unit 105 in response to the inquiry. The informing part 1023 also sends information about whether or not there is an advertisement presently on display (with the ID of the advertisement, if affirmative) and the status of display of advertisement. While in the system according to the embodiment the server apparatus 20 periodically sends an inquiry to the vehicle 10, the vehicle 10 may periodically send the aforementioned information to the server apparatus 20 by push communication alternatively. In this alternative case, the processing of step S11 may be executed at a point in the process different from that in FIG. 9.

Then, in step S12, the advertisement distribution part 2031 determines whether or not the subject vehicle 10 (namely, the vehicle for which this process is being performed) is presently displaying an advertisement. If a negative determination is made, the process proceeds to step S13, where the advertisement distribution part 2031 retrieves one or more advertisements that the subject vehicle 10 can display.

Whether or not there are advertisements that a certain vehicle 10 can display can be determined by whether or not the properties of the vehicle 10 meet the condition set for each advertisement. For example, in the case where a condition relating to the type of the vehicle and its display apparatus is set for an advertisement as shown in columns 503 in the table in FIG. 5, whether or not the advertisement can be displayed is determined by whether or not the properties of the vehicle 10 meet the condition.

If there is an advertisement(s) for which the subject vehicle 10 meets the condition, information relating to the advertisement(s) is extracted and stored temporarily.

A determination as to whether or not conditions relating to the area and time among the conditions set for an advertisement are met is not made in this step. This is because whether such conditions are met or not changes depending on the state of travel of the vehicle 10. This determination is made by the vehicle 10 to which the advertisement has been distributed, and whether or not the advertisement can be displayed is determined by the vehicle 10. If it is apparent that a condition set for an advertisement will not be met, that advertisement may be excluded in this step.

Then, in step S14, it is determined whether or not a request for display of the advertisement(s) is to be made to the subject vehicle 10. For example, if one or more advertisements were extracted in step S13, an affirmative determination is made in this step. Then, in step S15, advertisement data associated with the extracted advertisement(s) is sent to the subject vehicle 10.

If an affirmative determination is made in step S12, it means that the subject vehicle 10 has already been travelling while displaying a certain advertisement. Then, in step S16, the travel record table is updated using the location information and the advertisement ID received from the vehicle 10. Specifically, the vehicle management part 2032 adds a record containing the vehicle ID, the date and time, the location information, the status, and the ID of the displayed advertisement to the travel record table stored in the travel record database 202C.

Then, in step S17 it is determined whether or not there is a vehicle(s) that is to stop displaying the advertisement. In this step, it is determined whether or not there is an advertisement(s) for which the condition for ending the display is met on the basis of information received from the vehicles 10. For example, in the case where a total display time is designated for a certain advertisement, if the total display time of this advertisement has elapsed, it is determined that display of this advertisement is to be ended. Furthermore, if the operation (or travel) of a vehicle 10 that displays a certain advertisement ends (e.g. if the ignition is turned off), it is determined that display of this advertisement is to be ended.

If an affirmative determination is made in step S17, the process proceeds to step S18, where display of advertisement by the pertinent vehicle(s) is ended. Specifically, the advertisement distribution part 2031 sends a command to end the display of advertisement to the pertinent vehicle(s) 10.

The above-described process is executed repeatedly for every vehicle 10 under the management of the server apparatus 20.

Next, a process executed by the vehicle 10 will be described.

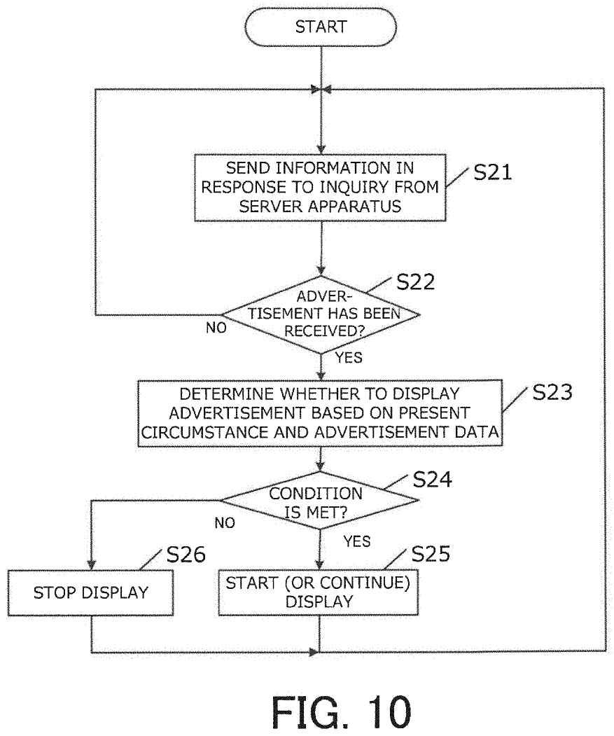

FIG. 10 is a flow chart of a process executed by the vehicle 10. The process illustrated in FIG. 10 is executed by the vehicle 10 periodically. The vehicle 10 receives advertisement data anytime when it is sent from the server apparatus 20 and stores the advertisement data.

Firstly in step S21, in response to the inquiry from the server apparatus 20, the informing part 1023 sends location information acquired by the location information acquisition unit 105, information indicating the presence/absence of displayed advertisement (with its ID, if present), and information about the status of display of advertisement to the server apparatus 20.

While in the system according to this embodiment the vehicle 10 sends information in response to the inquiry sent from the server apparatus 20, the vehicles 10 may send the aforementioned information to the server apparatus 20 at predetermined intervals by push communication alternatively. In this alternative case, the processing of step S21 may be executed at a point in the process different from that in FIG. 10.

Then, in step S22, it is determined whether or not the advertisement outputting part 1022 has already received advertisement data from the server apparatus 20. If a negative determination is made in this step, the process returns to step S21. If an affirmative determination is made, the process proceeds to step S23, where it is determined whether or not the advertisement is to be displayed on the basis of comparison between the present circumstance and the condition set in the advertisement data.

For example, if it is designated in the advertisement data that the advertisement should be displayed only in a designated area, whether the advertisement is to be displayed or not is determined on the basis of the result of comparison of the condition relating to the area and the location information acquired by the location information acquisition unit 105. If it is designated in the advertisement data that the advertisement should be displayed only in a designated time period, whether the advertisement is to be displayed or not is determined on the basis of the result of comparison of the condition relating to the time period and the present date and time.

While area and time period are given as examples of conditions for determining whether the advertisement is to be displayed or not, other conditions based on which the vehicle 10 can make the determination may be set.

If the result of determination in step S23 indicates that the condition is met (Yes in step S24), the process proceeds to step S25, where display of the advertisement is started (or continued, if the advertisement has already been displayed). If the condition is not met (No in Step S24), the process proceeds to step S26, where display of the advertisement is ended.

The vehicle 10 displays the advertisement by the above process.

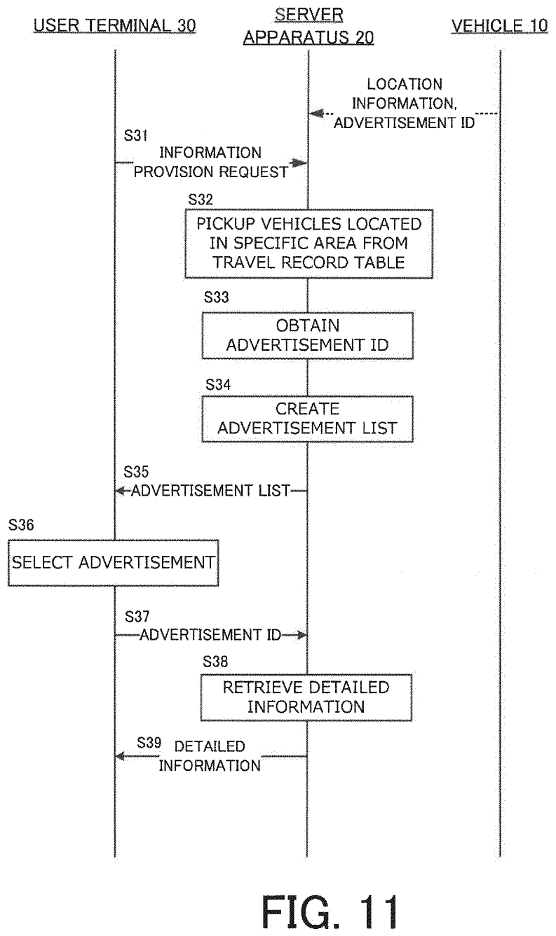

The process through which a user who have seen an advertisement displayed by the vehicle 10 acquires detailed information of the advertisement will be described with reference to a flow chart in FIG. 11.

Firstly in step S31, the user sends a request for providing information (which will be referred to as “information provision request”) to the server apparatus 20 through the user terminal 30 that the user has. For example, the information provision request is sent by application software for accessing advertisement information installed in the user terminal 30. The information provision request contains location information of the user terminal 30 acquired by the location information acquisition unit 303. The information provision request may be sent through a web browser or the like.

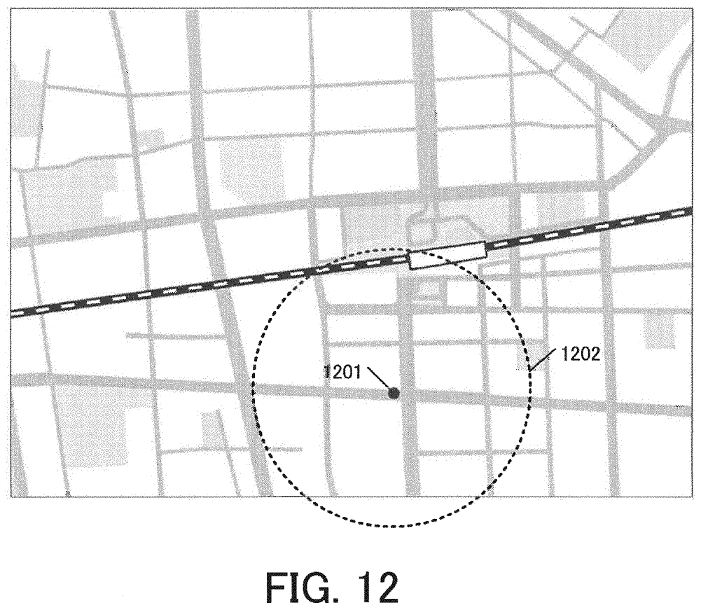

Then, in step S32, the server apparatus 20 consults the travel record table stored in the travel record database 202C to pick up vehicles 10 located in a specific area including the location indicated by the information provision request sent from the user terminal 30. For example, referring to FIG. 12, if the user terminal 30 is at the location indicated by “1201”, vehicles 10 that are present in a specific area indicated by “1202” including this location are picked up.

The picked-up vehicles are not necessarily located in the aforementioned specific area. For example, vehicles that are supposed to be present in the specific area at the time indicated by the request for providing information may be picked up. In this way, the processing may take account of a time lag additionally.

Then in step S33, the server apparatus 20 obtains the identification data of the advertisement that were displayed by the picked-up vehicles. Specifically, the server apparatus 20 consults the travel record table to obtain a list of the advertisement IDs of the advertisements that where displayed by the picked-up vehicles 10 at the time indicated by the information provision request.

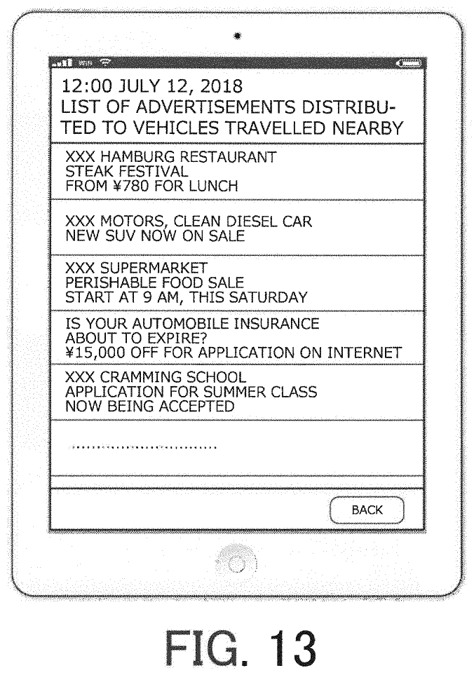

Then in step S34, the server apparatus 20 creates a list of advertisements (which will be referred to as “advertisement list”) to be provided to the user terminal 30 on the basis of the list of the advertisement IDs obtained in step S33 and the advertisement data stored in the advertisement information table. The advertisement list is provided in a format that allows the user to select one of the advertisements in the list. The advertisement list may be created as an HTML file. An example of the advertisement list created in step S34 is illustrated in FIG. 13. The advertisement list may be created using summary information included in the advertisement data.

The items in the advertisement list may be sorted according to the distance between the user terminal 30 and the vehicle 10. For example, the advertisements may be sorted in the advertisement list from above to below according to the closeness of the vehicles 10 that displayed the advertisements to the user terminal 30. The advertisement list thus created is sent to the user terminal 30 in step 35 for the user to see it.

When the user selects one of the advertisements in the advertisement list (step S36), the user terminal 30 sends the advertisement ID of the selected advertisement to the server apparatus 20 (Step S37).

Then, the server apparatus 20 consults the advertisement information table to retrieve the detailed information included in the advertisement data corresponding to the advertisement ID designated by the user (step S38) and sends the detailed information to the user terminal 30 (step S39). Thus, the user can get information relating to the advertisement displayed by the vehicle 10.

In the system according to the first embodiment, the vehicles 10 receive advertisement data from the server apparatus 20, and each vehicle 10 displays an advertisement on its outside display. As above, the system according to the first embodiment enables a user who have seen the advertisement to access detailed information of the advertisement easily. Since the user terminal does not directly communicate with the moving vehicle, obtainment of the detailed information can be carried out reliably.

### Second Embodiment

In system according to the first embodiment, when an information provision request is sent from the user terminal 30, the server apparatus picks up vehicles 10 that displayed advertisements only on the basis of the locations of the user terminal 30 and the vehicles 10 (namely, positional relationship between the user terminal and the vehicles). In the system according to the second embodiment, the server apparatus picks up vehicles 10 taking account of the time in addition to the positional relationship.

In the system according to the second embodiment, the information provision request sent in step S31 in the above-described process illustrated in FIG. 11 includes time information in addition to location information. The time information is information indicating the time (i.e. date and time) at which the user saw an advertisement.

In the process of picking up vehicles in step 32, the server apparatus 20 in the system according to the second embodiment takes into account the time difference in addition to the distance. Specifically, the server apparatus 20 picks up vehicles 10 whose distance to the user terminal 30 in a time-space network is shorter than a predetermined distance. In other words, in picking up vehicles 10, the server apparatus gives higher priority to vehicles 10 that are closer to the user terminal 30 geographically and in terms of time.

In the process of picking up vehicles 10 in step S32 and the process of creating an advertisement list in step S34, the server apparatus 20 may perform prioritization based on the distance in the time-space network. For example, vehicles 10 with shorter distances to the user terminal 30 in the time-space network may be given higher priority in the picking-up process, and advertisements associated with such vehicles 10 may take higher places in the advertisement list.

Thus, it is possible to give priority to the advertisement displayed by the vehicle 10 seen by the user when providing information to the user.

(Modifications)

The above embodiments are only for the illustrative purpose. Appropriate modifications can be made thereto without departing from the essence of the present disclosure.

For example, an expiration time may be set for information in the travel record table, and the control unit 203 may be configured to periodically delete the records that have expired.

Further, the control unit 203 may be configured to make a report about display of advertisements using information stored in the travel record table.

The processing and the units that have been described in the foregoing may be employed in any combinations so long as it is technically feasible to do so.

A process described to be performed by one apparatus may be performed by a plurality of apparatuses in a distributed manner. A process described to be performed by different apparatuses may be performed by a single apparatus. The hardware configuration (or server configuration) employed to implement the functions of a computer system may be modified flexibly.

The present disclosure can be carried out by supplying a computer program(s) that implements the functions described in the above description of the embodiments to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD disc and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus comprising:
a storage unit configured to store travel record information that contains identification data of advertisements displayed respectively by display apparatuses provided on a plurality of vehicles and records of location information of the vehicles by which the advertisements are displayed, the identification data of the advertisements and the records of location information being associated with each other;
a controller configured to
receive a data retrieval request sent from a user terminal and containing information about the location of the user terminal,
pick up one or more vehicles located close to the user terminal on the basis of the data retrieval request and the travel record information,
create a list of advertisements displayed by the picked-up vehicles, and
send the list of advertisements to the user terminal.

2. An information processing apparatus according to claim 1, wherein
the controller obtains the identification data of an advertisement selected from the list by the user terminal, retrieves detailed information associated with the advertisement selected by the user terminal, and sends the detailed information to the user terminal.

3. An information processing apparatus according to claim 1, wherein
the travel record information comprises information representing the locations of the vehicles at respective points in time,
the data retrieval request further contains information indicating a first point in time designated by the user terminal, and
the controller is configured to further use the first point in time in picking up vehicles.

4. An information processing apparatus according to claim 3, wherein
when creating the list by picking up vehicles, the controller gives priority to vehicles whose distance to the user terminal in a time-space network is short.

5. An information processing apparatus according to claim 1, wherein
the controller periodically receives location information of the vehicles that are travelling and updates the travel record information.

6. An information processing method comprising the steps of:
obtaining travel record information that contains identification data of advertisements displayed respectively by display apparatuses provided on a plurality of vehicles and records of location information of the vehicles by which the advertisements are displayed, the identification data of the advertisements and the records of location information being associated with each other;
receiving a data retrieval request sent from a user terminal and containing information about the location of the user terminal;
picking up one or more vehicles located close to the user terminal on the basis of the data retrieval request and the travel record information; and
creating a list of advertisements displayed by the picked-up vehicles and sending the list of advertisements to the user terminal.

7. A non-transitory computer readable storing medium recording a computer program for causing a computer to perform an information processing method comprising the steps of:
obtaining travel record information that contains identification data of advertisements displayed respectively by display apparatuses provided on a plurality of vehicles and records of location information of the vehicles by which the advertisements are displayed, the identification data of the advertisements and the records of location information being associated with each other;
receiving a data retrieval request sent from a user terminal and containing information about the location of the user terminal;
picking up one or more vehicles located close to the user terminal on the basis of the data retrieval request and the travel record information; and
creating a list of advertisements displayed by the picked-up vehicles and sending the list of advertisements to the user terminal.
